(19) United States
(12) Patent Application Publication
(10) Pub. No.: US 2009/0196728 A1
(43) Pub. Date: Aug. 6, 2009

(54) Apparatus and Method

(75) Inventors: James Robert Basinger, New Hudson, MI (US); Michael Dale Clayton, Lake Orion, MI (US); Anthony John Lukasiewicz, Howell, MI (US); Steven William Toth, Linden, MI (US)

Correspondence Address: WARN, HOFFMANN, MILLER & LALONE, .P.C, PO BOX 70098, ROCHESTER HILLS, MI, 48307, US

(73) Assignee: ELOPAK SYSTEMS AG, Glattbrugg (CH)

(21) Appl. No.: 11/667,808

(22) PCT Filed: Nov. 15, 2005
(86) PCT No.: PCT/GB05/04404

§ 371 Date: Sep. 11, 2008

Related U.S. Application Data
(60) Provisional application No. 60/628,319, filed on Nov. 16, 2004.

(51) Int. Cl. B65G 59/06; B65G 61/00

(52) U.S. Cl. 414/801; 414/797.5

(57) ABSTRACT

Associated with a form-fill-seal packaging machine for liquid-packaging cartons is an apparatus (10) including a pusher (24) for driving a pour spout fitment (12) axially from a removal-ready position at an exit end (14) of a feed track (16) that serially guides pour spout fitments (12, 30) edge-wise to the exit end (14) such that external, circumferential flanges (18) of adjacent pour spout fitments (12) and (30) tend to overlap one another. The apparatus (10) also includes a pour spout fitment separator (28) supported adjacent the exit end (14) for reversing an immediately following pour spout fitment (30) back along the track (16) to a position where the flange (18) of the leading fitment (12) in the removal-ready position and the flange (18) of the immediately following pour spout fitment (30) do not overlap.

This invention relates generally to a singulating method and singulating apparatus for pour spout fitments in a pour spout fitment feed track to overcome interference between a leading fitment and a next following fitment, particularly but not necessarily, to enable the leading fitment to be pushed axially of itself from the exit end of the track without interference from the next following fitment. The method and apparatus are particularly applicable to pour spout fitments having circumferential flanges that may overlap between adjacent fitments and, if not separated, may distort one another when one of the pour spout fitments is driven axially from the track.

It is known for pour spout fitments having circumferential flanges to be serially fed from a pour spout fitment source to an applicator along a feed track. The fitments each include a screw cap on a circumferentially-flanged pour spout. The flange of each spout provides a surface for affixing the pour spout fitment to the wall of a plastics-coated paperboard carton via heating or ultra-sonic welding. Once affixed to a carton, the cap can be unscrewed from the pour spout to allow the contents of the carton to be poured out.

The assignee of the present invention manufactures carton forming, capping, filling, and sealing machines, such as the Elopak® S90UC machines, which each include a gravity-feed, fitment feed track that serially guides pour spout fitments edge-wise such that central axes of the fitments are parallel to one another and that radially-extending circumferential flanges of the fitments abut or overlap one another. The feed track terminates as an escapement shaped to receive fitments supplied by the feed track and to hold one fitment at a time in a removal-ready position to be driven axially from the escapement. The Elopak® S90UC machine also includes a pour spout fitment pusher supported axially adjacent the escapement in a position to push one fitment at a time axially from the escapement and into engagement with a mandrel. However, the Elopak® S90UC machine is unable to prevent the circumferential flanges of the leading fitment and the next following fitment from overlapping one another and deforming as the leading fitment is driven from the escapement.

U.S. Pat. No. 5,150,559 discloses an apparatus for mounting onto fluid containers, in a predetermined particular orientation relative to the fluid containers, closures consisting of caps mounting pull-out, push-in tubular taps. The closures are drawn from a source of closures and placed singly, in succession, on a closure seat which is in a particular known orientation. Each closure is taken, while on the seat, to a delivery position. During transfer to the delivery position, each closure is aligned into a known particular orientation. A device for picking up the closures takes each closure from the seat and mounts the closure onto a waiting fluid container, in the desired predetermined orientation with respect to the fluid container. The device includes an operatively associated clamp that supports the container about a flange around the neck to prevent crushing of the container during mounting of the closures. The closures fall down a chute until they arrive at a drop position, where they are retained, in succession, in a trap which is formed by jaws. When a closure is fed into the trap, the jaws are closed. A gate is positioned to one side of the trap, to enable the closure to enter the trap, which has a wall to keep the closure from moving forward beyond the drop position. When the jaws are opened, the closure falls down onto the seat. In such a situation, in which the closures descend down the chute under the force of gravity, the sheer number of closures can cause a substantial thrusting force, or back pressure, to be exerted upon the closure which is actually within the trap. At times, the back pressure may be so great that the closure will be pinned with the trap and will not fall. Accordingly, the gate is provided to alleviate the back pressure created by the succeeding closures. When a seat is available and positioned below the trap, the jaws open and the gate is driven to block access to the trap. The leading edge of the gate is configured as a wedge, to drive the closure immediately above the trap (as well as all succeeding closures) backward slightly, taking back pressure off the closure in the trap, permitting it to drop freely. Once the closure in the trap has fallen, then the jaws are closed and the gate is moved back to its original position, to one side of the trap.

U.S. Pat. No. 6,807,792 discloses a pour spout fitment feed system for use on an associated form, fill and seal packaging machine and for feeding circumferentially flanged pour spout fitments from a fitment storage region to a fitment applicator. The feed system includes a chute for conveying the fitments under gravity from the storage region down to the applicator along a conveyance path. It discloses that a phenomenon known as shingling occurs in which the thin flanges of the closures overlap one another and cause skewing of closures. This in turn can cause the closures to jam within the feed system. Therefore, there is included in the system a singulator which includes upper and lower reciprocating members for alternatingly reciprocating into and out of the conveyance path. The upper member includes a wedge-form separating element which moves into and out of the conveyance path in a sense transverse to the chute and diametrical of the adjacent fitments, the wedge acting between screw caps of the leading fitment and the next following fitment. In one embodiment, the separating element has its lower surface substantially horizontal and its upper surface oblique to the horizontal, so as to reverse back up the chute that next following fitment and the fitments supplied by it.

According to one aspect of the present invention, there is provided apparatus comprising:—
a feed track serving to guide each fitment of a series of pour spout fitments from
an upper end zone of said track to a lower end thereof,
a removing device in the region of said lower end for removing from said track
a leading fitment of said series in a removal-ready position at said lower end, and
a singulator including a lifting device serving with said leading fitment in its removal-ready position, to lift away from said leading fitment the next following fitment.

According to a second aspect of the present invention, there is provided a method comprising using a guide track to guide each fitment of a series of pour spout fitments from an upper end zone to a lower end of said track using a lifting device to lift away from the leading fitment of said series, which leading fitment is in a removal-ready position, the next following fitment in said track, and removing said leading fitment from said track without substantially any interference from said next following fitment.

Owing to these two aspects of the invention, it is possible to ensure not only that the next following fitment does not interfere with the leading fitment during removal of the latter, but also that the leading fitment is in its removal-ready position before the force thereon of the following fitment(s) is taken away, which otherwise might result in the leading fitment's stopping moving towards its removal-ready position. According to a third aspect of the present invention, there is provided apparatus comprising:—

a feed track serving to guide each fitment of a series of pour spout fitments from an upper end zone of said track to a lower end zone thereof, and a singulator including a lifting device serving to lift away from said leading fitment the next following fitment, said lifting device being arranged to act upon said next following fitment in a sense other than in a sense transverse to said track and diametrical of said next following fitment.

According to a fourth aspect of the present invention, there is provided a method comprising using a guide track to guide each fitment of a series of pour spout fitments from an upper end zone to a lower end zone of said track, and using a lifting device to lift away from the leading fitment of said series the next following fitment in said track, and removing said leading fitment from said track said lifting device acting upon said next following fitment in a sense other than in a sense transverse to said track and diametrical of that fitment.

Owing to these two aspects of the invention, it is possible to avoid risk of damage to the next following fitment, which might occur through that fitment's being pressed laterally against a longitudinal surface of the track.

In a preferred embodiment, an apparatus is provided for driving a pour spout fitment axially from an ejection position in an escapement at an exit end of a pour spout fitment feed track that is configured to guide serially a plurality of pour spout fitments edge-wise along the feed track to the exit end such that central axes of the fitments are generally parallel to one another along the feed track and such that radially-extending circumferential flanges of adjacent fitments disposed in the feed track tend to overlap one another. The apparatus comprises a pour spout fitment pusher supported adjacent the exit end of the feed track and configured to engage a fitment in the ejection position and to push that fitment axially from the exit end of the feed track. A pour spout fitment separator is supported adjacent the exit end and is configured to reverse an immediately following fitment back along the feed track to a clear position where the flange of the fitment in the ejection position and the flange of the immediately following fitment do not overlap one another. This prevents the flanges of the fitments from interfering with one another and deforming as the fitment in the escapement is driven axially from the escapement.

In order that the invention may be clearly and completely disclosed, reference will now be made, by way of example, to the accompanying drawings, in which:

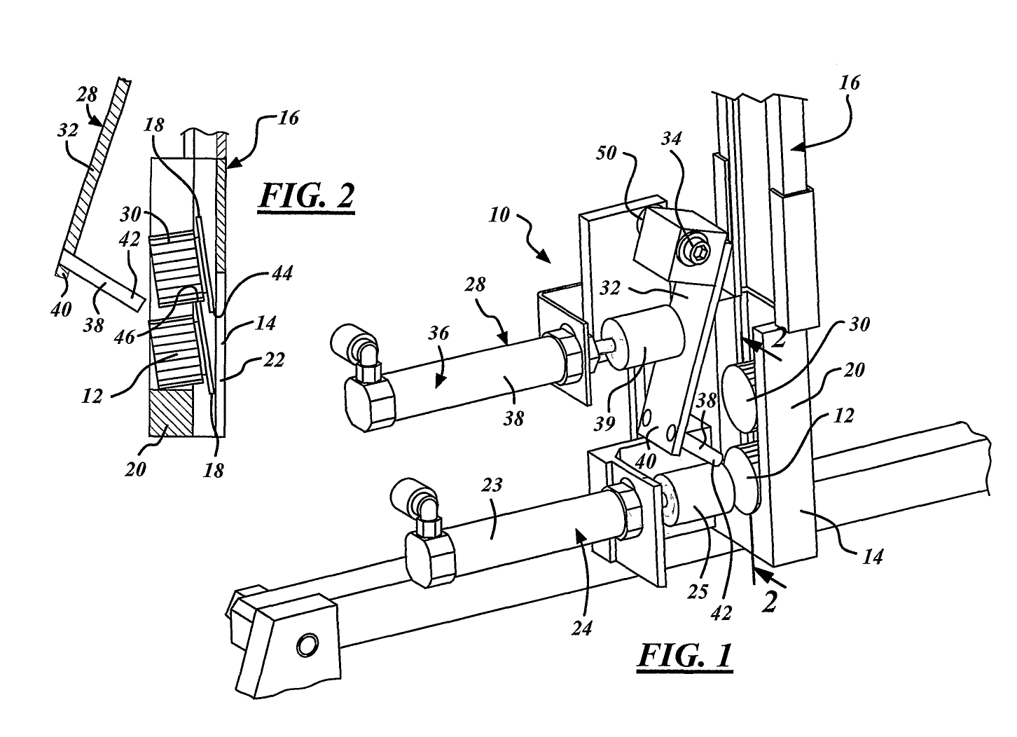

FIG. 1 is a fragmentary orthogonal view of an apparatus for delivering pour spout fitments one-by-one and showing a separator arm and a pusher mechanism of the apparatus in respective retracted positions;

FIG. 2 is a fragmentary, vertical sectional view taken along the line 2-2 of FIG. 1;

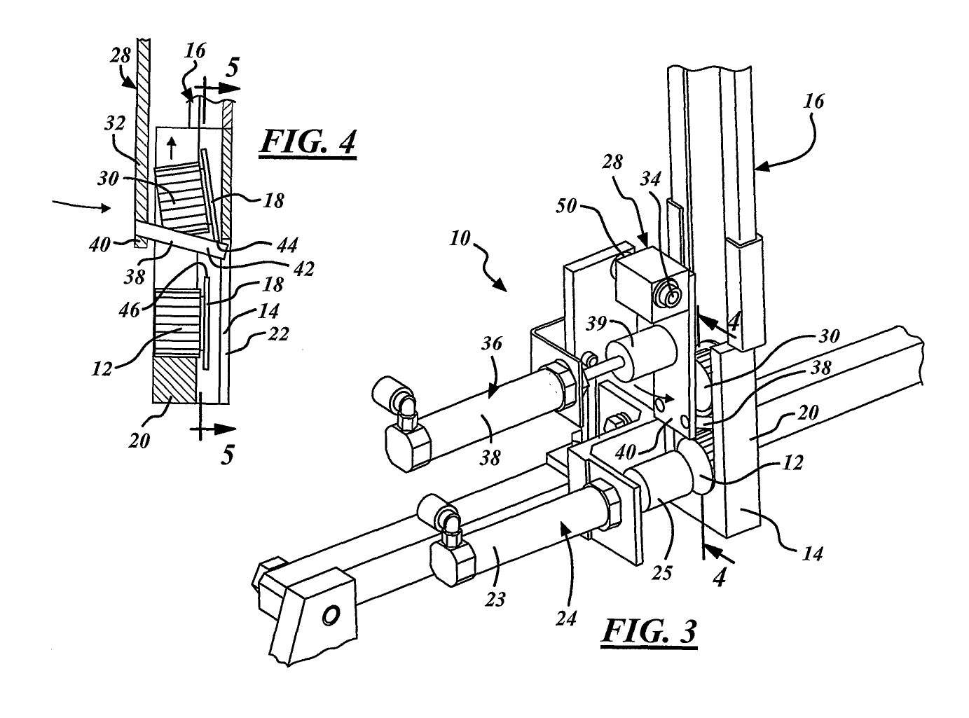

FIG. 3 is a view similar to FIG. 1, but showing the separator arm in an engaged position;

FIG. 4 is a view similar to FIG. 2, but taken along the line 4-4 of FIG. 3;

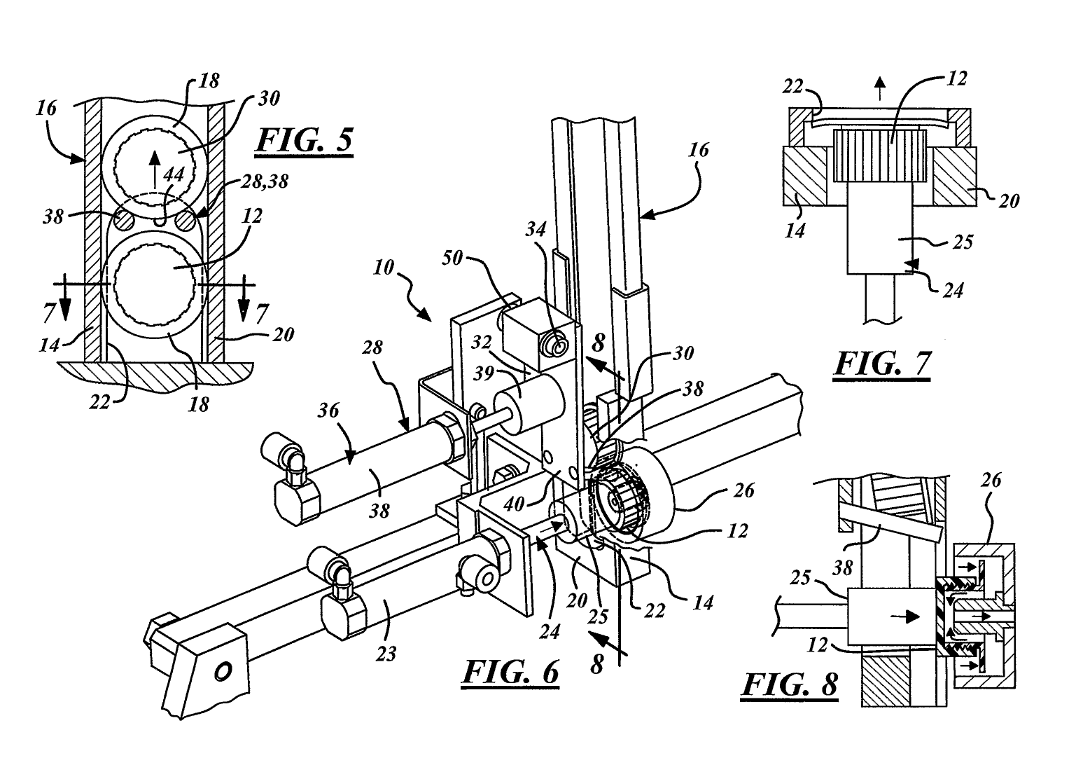

FIG. 5 is a fragmentary, vertical sectional view taken along the line 5-5 of FIG. 4;

FIG. 6 is a view similar to FIG. 1, but showing the separator arm in the engaged position and the pusher mechanism in a pushing position;

FIG. 7 is a fragmentary, horizontal sectional view taken along the line 7-7 of FIG. 5, but showing an external, circumferential flange of a fitment being deflected as the fitment is pushed from an escapement; and

FIG. 8 is a view similar to FIG. 4, but taken along the line 8-8 of FIG. 6.

An apparatus for delivering pour spout fitments is generally shown at 10 in the drawings. The apparatus 10 is designed to drive a pour spout fitment 12 axially from a removal-ready position at an exit, i.e. lower, end 14 of a pour spout fitment gravity feed track 16. The removal-ready position is the position occupied by the fitment 12 in FIGS. 3 to 5. The feed track is of a character that serially guides a plurality of pour spout fitments 12, 30 edge-wise to the exit end 14 and does so in such a way that central axes of the fitments 12, 30 are generally parallel to one another along the feed track 16 and such that radially-extending, annular circumferential flanges 18 of adjacent pour spout fitments 12, 30 disposed in the feed track 16 tend to overlap one another, as best shown in FIG. 2. It will be understood that above the fitment 30 would normally be a column of unillustrated fitments bearing down upon the fitment 30 and upon each other.

The apparatus 10 also includes an escapement 20 disposed at and defining the exit end 14 of the feed track 16. The escapement 20 is shaped and positioned to receive pour spout fitments 12, 30 supplied by the feed track 16, to hold one fitment 12 at a time in the removal-ready position, and includes an opening 22 shaped to allow a leading fitment 12 to be driven axially from the escapement 20 as shown in FIGS. 6 to 8.

A pour spout fitment pusher 24 is supported axially adjacent the escapement 20 at the exit end 14 of the feed track 16. The pusher 24 includes an air cylinder 23 that drives a plunger 25 into contact with the leading fitment 12 and pushes that fitment 12, and succeeding pour spout fitments, one fitment at a time, axially of themselves from the escapement 20 and into engagement with a liquid packaging carton wall, a mandrel, or the like. In the embodiment shown in the drawings, the pusher 24 pushes fitments 12 from the escapement 20 onto cap fitment carriers in the form of spigots 26 that transport the fitments 12 to another location to be mounted on cartons. As shown in FIG. 8, the carrier may include a spigot 26 of a character that employs vacuum suction to help retain the fitments in the spigots 26 during transport.

If the leading fitment 12 and the next following fitment 30 arrive at the bottom of the track 16 with the flanges 18 overlapping each other as shown in FIG. 2, pushing of the fitment 12 out of the escapement 20 by the pusher 24 would be likely to distort the flanges 18 of both of the fitments. For this reason, the apparatus 10 incorporates a pour spout fitment separator 28 which is supported adjacent the escapement 20 at the exit end 14 of the feed track 16 and causes a next following pour spout fitment 30 to reverse back along the feed track 16 to a clear position where the circumferential flange of the leading fitment 12 in the removal-ready position and the circumferential flange of the immediately following fitment 30 do not overlap one another. The clear position is the position that the fitment 30 occupies in FIGS. 3, 4, 5, 6 and 8. Moving the fitment 30 to the clear position prevents the circumferential flanges 18 of the fitments 12 and 30 from interfering with one another as the pusher 24 drives the leading fitment 12 axially from the escapement 20.

The separator 28 includes a separator arm 32 mounted on a pivot pin 34 for pivotal motion about the pivot pin between a retracted position clear of the track 16 and an engaged position adjacent the track 16 and spaced from the exit end 14 of the feed track 16. The separator arm 32 is shown in its retracted position in FIGS. 1 and 2 and is shown in its engaged position in FIGS. 3, 4, 5, 6 and 8. Motion of the separator arm 32 from the retracted position to the engaged position causes the separator arm 32 to engage and reverse the immediately following fitment 30 back along the feed track 16 to the clear position best shown in FIGS. 4 and 5.

The separator also includes a separator arm drive 36 that is drivingly connected to the separator arm 32. When actuated, the drive 36 pivots the separator arm 32 from the retracted position to the engaged position. According to the present embodiment, the drive 36 includes a horizontally-oriented air cylinder 38 that drives a plunger 39. However, other embodiments may include any suitable drive device.

As is best shown in FIGS. 1, 2, and 4, two separator fingers 38 are supported on the separator arm 32 at respective locations spaced from the separator arm pivot and adjacent a lower end 40 of the arm 32. The fingers extend diagonally outward and downward from the lower end 40 of the separator arm 32 such that distal ends 42 of the separator fingers push between a lower edge portion 44 of the flange of the next following fitment 30 and an upper edge portion 46 of the flange of the leading fitment 12 in the escapement 20 when the separator drive 36 drives the separator arm 32 toward the engaged position against the feed track 16. As shown in FIGS. 1, 3, and 6, the separator 28 includes a spring 50 positioned to bias the separator arm 32 to the retracted position, allowing the next following fitment 30 to fall to the removal-ready position in the escapement 20 and become the leading fitment 12.

By precluding interference between the respective circumferential flanges 18 of the leading and immediately following fitments 12 and 30, the pour spout fitment separator 28 allows the leading fitments 12 to be driven axially from the exit end 14 of the track 16 without distorting the circumferential flanges of the pour spout fitments.

It will be noted that, since the leading fitment 12 is supported by the end 14 of the track 16 during singulation, it is possible to use only one singulating mechanism (28).

We claim:

1-18. (canceled)

19. Apparatus comprising:—
a feed track serving to guide each fitment of a series of pour spout fitments from an upper end zone of said track to a lower end thereof,
a removing device in the region of said lower end for removing from said track a leading fitment of said series in a removal-ready position at said lower end, and
a singulator including a lifting device serving, with said leading fitment in its removal-ready position, to lift away from said leading fitment the next following fitment.

20. Apparatus according to claim 19, wherein said lifting device is arranged to act upon said next following fitment in a sense other than in a sense transverse to said track and diametrical of said next following fitment.

21. Apparatus according to claim 19, in which said lifting device comprises an arm mounted for pivotal motion between a retracted condition clear of the track and an engaged condition such that motion from said retracted condition to said engaged condition causes said arm to engage the next following fitment and reverse the same back along the track, said singulator further comprising an arm drive drivingly connected to said arm and serving to turn said arm from said retracted condition into said engaged condition.

22. Apparatus according to claim 21, wherein said track serves diametrically to embrace circumferential flanges of said fitments and wherein the lifting device includes two fingers supported on said arm in positions spaced from a pivot axis of said arm, the fingers extending diagonally outward and downward from the separator arm such that distal ends of the fingers push between a lower edge portion of the flange of said next following fitment and an upper edge portion of the flange of said leading fitment when said arm moves towards said track.

23. Apparatus according to claim 22, wherein said fingers extend diagonally outward and downward from said arm.

24. Apparatus according to claim 21, in which the singulator includes a biasing device serving to bias said arm into its retracted condition.

25. Apparatus according to claim 19, wherein said removing device comprises a fitment pusher arranged to push said leading fitment axially of said leading fitment from said track.

26. A method comprising:—
using a guide track to guide each fitment of a series of pour spout fitments from an upper end zone to a lower end of said track,
using a lifting device to lift away from the leading fitment of said series, which leading fitment is in a removal-ready position, the next following fitment in said track, and
removing said leading fitment from said track without substantially any interference from said next following fitment.

27. A method according to claim 26, wherein said lifting is produced by causing said lifting device to act upon said next following fitment in a sense other than in a sense transverse to said track and diametrical of that fitment.

28. A method according to claim 26, wherein said track embraces diametrically circumferential flanges of the fitments therein, and wherein said lifting is produced by causing said lifting device to push between a lower edge portion of the flange of said next following fitment and an upper edge portion of said leading fitment.

29. A method according to claim 26, wherein said removing comprises pushing said leading fitment axially of itself from said track.

30. Apparatus comprising:—
a feed track serving to guide each fitment of a series of pour spout fitments from an upper end zone of said track to a lower end zone thereof, and
a singulator including a lifting device serving to lift away from said leading fitment the next following fitment, said lifting device being arranged to act upon said next following fitment in a sense other than in a sense transverse to said track and diametrical of said next following fitment.

31. Apparatus according to claim 30, in which said lifting device comprises an arm mounted for pivotal motion between a retracted condition clear of the track and an engaged condition such that motion from said retracted condition to said engaged condition causes said arm to engage the next following fitment and reverse the same back along the track, said singulator further comprising an arm drive drivingly connected to said arm and serving to turn said arm from said retracted condition into said engaged condition.

32. Apparatus according to claim 31, wherein said track serves diametrically to embrace circumferential flanges of said fitments and wherein the lifting device includes two fingers supported on said arm in positions spaced from a pivot axis of said arm, the fingers extending diagonally outward and downward from the separator arm such that distal ends of the fingers push between a lower edge portion of the flange of said next following fitment and an upper edge portion of the flange of said leading fitment when said arm moves towards the said track.

33. Apparatus according to claim 32, wherein said fingers extend diagonally outward and downward from said arm.

34. Apparatus according to claim 31, in which the singulator includes a biasing device serving to bias said arm into its retracted condition.

35. A method comprising:—
using a guide track to guide each fitment, of a series of pour spout fitments from an upper end zone to a lower end zone of said track, and
using a lifting device to lift away from the leading fitment of said series the next following fitment in said track, said lifting device acting upon said next following fitment in a sense other than in a sense transverse to said track and diametrical of said next following fitment.

36. A method according to claim 35, wherein said track embraces diametrically circumferential flanges of the fitments therein, and wherein said lifting is produced by causing said lifting device to push between a lower edge portion of the flange of said next following fitment and an upper edge portion of said leading fitment.
